(19) United States
(12) Patent Application Publication
(10) Pub. No.: US 2024/0119238 A1
(43) Pub. Date: Apr. 11, 2024

(54) SYSTEMS AND METHODS FOR DETERMINING SEMANTIC POINTS IN HUMAN-TO-HUMAN CONVERSATIONS

(71) Applicant: Samsung Electronics Co., Ltd., Suwon-si, Gyeonggi-do (KR)

(72) Inventors: Ranjan Kumar SAMAL, Odisha (IN); Vivek Paul JOSEPH, Kozhikode (IN); Raghavendra Hanumatasetty RAMASETTY, Bangalore (IN)

(21) Appl. No.: 18/485,726

(22) Filed: Oct. 12, 2023

Related U.S. Application Data
(63) Continuation of application No. PCT/KR2023/015512, filed on Oct. 10, 2023.

(30) Foreign Application Priority Data
Oct. 10, 2022 (IN) 202241057971

(51) Int. Cl. G06F 40/35; G06F 40/166

(52) U.S. Cl. CPC G06F 40/35; G06F 40/166

(57) ABSTRACT

A system and a method for determining semantic points in a human-to-human conversation is provided. The method includes identifying the human-to-human conversation including a plurality of dialogue turns and determining natural language (NL) attributes form each dialogue turn. Further, the method includes deriving a transient state, based on the one or more NL attributes. Further, the method includes deriving one or more conversation nuances associated with the human-to-human conversation based on the one or more NL attributes. Moreover, the method includes dynamically storing information associated with the human-to-human conversation based on the one or more NL attributes, the transient state, and the one or more conversation nuances associated with each dialogue turn and determining one or more semantic relations and associated dialogue timelines within the human-to-human conversation based on the dynamically stored information. Additionally, the method includes generating semantic points corresponding to the determined one or more semantic relations and the associated dialogue timelines within the human-to-human conversation.

### CROSS-REFERENCE TO RELATED APPLICATION(S)

This application is a continuation application, claiming priority under § 365(c), of an International application No. PCT/KR2023/015512, filed on Oct. 10, 2023, which is based on and claims the benefit of an Indian patent application number 202241057971, filed on Oct. 10, 2022, in the Indian Intellectual Property Office, the disclosure of which is incorporated by reference herein in its entirety.

### FIELD OF THE INVENTION

The disclosure relates to natural language processing. More particularly, the disclosure relates to systems and methods for determining semantic points in a human-to-human conversation.

### BACKGROUND

With the recent advancements in mobile communication, online messaging platforms have gained popularity as an easy mode of communication. Such messaging platforms enable users to transmit messages including text or graphics among users. Further, some messaging platforms allow implementation of chat rooms and/or groups in which a plurality of users may simultaneously participate to discuss one or more common topics.

However, with multiple users sending messages in such chat rooms or groups, sometimes it become tough to extract or search for a relevant information. Further, conventional searching techniques merely enable keyword-based search, which is time consuming, and is cumbersome as a user has to analyze all the search results and arrive at an intended conclusion.

Some dialogue summarization tools are also available, which merely combine one or more dialogues of one or more users to form a single dialogue segment. However, such tools are unable to find dialogues responsible for an intended conclusion. In general, dialogue understanding is categorized in three categories, namely human-bot conversation (HBC), human-human conversation (HHC) and bot-bot conversation (BBC). Out of the three above-mentioned dialogue categories, HBC is highly goal orientated, structured and predictable in nature, while BBC is rarely used. However, the HHC is very unstructured form of conversation with lot of uncertainty. Hence, the conventional systems fail to effectively understand the HHCs.

Further, as discussed above, techniques which attempt to understand the HHCs are highly time consuming. In particular, such techniques involve processing of each message within a dialogue conversation. Further, it is difficult to extract and/or navigate to a specific information within such dialogue conversation, as such conversation includes a chain of messages including information pertaining to multiple topics. Also, such techniques generate too many notifications and undesired suggestions which may lead to user anxiety and are highly undesirable.

Accordingly, there is a need for a system which can process a human-to-human conversation and identify semantic points in the conversation to effectively identify the intended conclusion of the conversation.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide introducing a selection of concepts, in a simplified format, that are further described in the detailed description of the disclosure. This summary is neither intended to identify key or essential inventive concepts of the disclosure and nor is it intended for determining the scope of the disclosure.

Additional aspects will be set forth in part in the description which follows and, in part, will be apparent from the description, or may be learned by practice of the presented embodiments.

In accordance with an aspect of the disclosure, a method for determining semantic points in a human-to-human conversation is provided. The method includes identifying the human-to-human conversation, comprising a plurality of dialogue turns, on an electronic device. Further, the method includes determining, for each dialogue turn of the plurality of dialogue turns, one or more natural language (NL) attributes. Furthermore, the method includes deriving, for each dialogue turn, a transient state, based on the one or more NL attributes. Furthermore, the method includes deriving, for each dialogue turn, one or more conversation nuances associated with the human to human conversation, based on the one or more NL attributes. Furthermore, the method includes dynamically storing, at one or more memories, after each dialogue turn, information associated with the human-to-human conversation based on the one or more NL attributes, the transient state, and the one or more conversation nuances associated with each dialogue turn. Additionally, the method includes determining one or more semantic relations and associated dialogue timelines within the human-to-human conversation based on the dynamically stored information. Moreover, the method includes generating semantic points corresponding to the determined one or more semantic relations and the associated dialogue timelines within the human-to-human conversation.

In accordance with another aspect of the disclosure, a system for determining semantic points in a human-to-human conversation is provided. The system includes an identifying module configured to identify the human-to-human conversation, comprising a plurality of dialogue turns, on an electronic device. Further, the system includes a natural language (NL) attribute generator module configured to determine, for each dialogue turn of the plurality of dialogue turns, one or more NL attributes. Furthermore, the system includes a transient state estimator module configured to derive, for each dialogue turn, a transient state based on the one or more NL attributes. Also, the system includes a conversation nuance (CN) classifier module configured to derive, for each dialogue turn, one or more conversation nuances associated with the human-to-human conversation based on the one or more NL attributes and one or more dialogue turns. Furthermore, the system includes a turn memory update module configured to dynamically store, at one or more memories, after each dialogue turn, information associated with the human-to-human conversation based on the one or more NL attributes, the transient state, and the one or more conversation nuances associated with each dialogue turn. Additionally, the system includes a hierarchical semantic point module configured to determine one or more semantic relations and associated dialogue timelines within the human-to-human conversation based on the dynamically stored information. The hierarchical semantic point module is further configured to generate the semantic points corresponding to the determined one or more semantic relations and the associated dialogue timelines within the human-to-human conversation.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an environment of a system for determining semantic points in a human-to-human conversation, according to an embodiment of the disclosure;

FIG. 2 illustrates a schematic block diagram of the system for determining semantic points in a human-to-human conversation, according to an embodiment of the disclosure;

FIG. 3A illustrates a schematic block diagram of modules and a conversation memory of the system for determining semantic points in a human-to-human conversation, according to an embodiment of the disclosure;

FIG. 3B illustrates an illustration of a human-to-human conversation for determining semantic points, according to an embodiment of the disclosure;

FIG. 3C illustrates an illustration of a human-to-human conversation for determining semantic points, according to an embodiment of the disclosure;

FIG. 4 illustrates an embodiment of a Natural Language (NL) attribute generator module, according to an embodiment of the disclosure;

FIG. 5 illustrates an embodiment of a transient state estimator module, according to an embodiment of the disclosure;

FIG. 6A illustrates an embodiment of a conversation nuances (CN) classifier module, according to various embodiments of the disclosure;

FIG. 6B illustrates an embodiment of a conversation nuances (CN) classifier module, according to various embodiments of the disclosure;

FIG. 7A illustrates an embodiment of a turn memory update module, according to various embodiments of the disclosure;

FIG. 7B illustrates an embodiment of a turn memory update module, according to various embodiments of the disclosure;

FIG. 7C illustrates an embodiment of a turn memory update module, according to various embodiments of the disclosure;

FIG. 7D illustrates an embodiment of a turn memory update module, according to various embodiments of the disclosure;

FIG. 8A illustrates an embodiment of a hierarchical semantic point module, according to various embodiments of the disclosure;

FIG. 8B illustrates an embodiment of a hierarchical semantic point module, according to various embodiments of the disclosure;

FIG. 8C illustrates an embodiment of a hierarchical semantic point module, according to various embodiments of the disclosure;

FIG. 9A illustrates various usage scenarios of the system for determining semantic points in a human-to-human conversation, according to various embodiments of the disclosure;

FIG. 9B illustrates various usage scenarios of the system for determining semantic points in a human-to-human conversation, according to various embodiments of the disclosure;

FIG. 9C illustrates various usage scenarios of the system for determining semantic points in a human-to-human conversation, according to various embodiments of the disclosure;

FIG. 9D illustrates various usage scenarios of the system for determining semantic points in a human-to-human conversation, according to various embodiments of the disclosure;

FIG. 9E illustrates various usage scenarios of the system for determining semantic points in a human-to-human conversation, according to various embodiments of the disclosure;

FIG. 9F illustrates various usage scenarios of the system for determining semantic points in a human-to-human conversation, according to various embodiments of the disclosure;

FIG. 9G illustrates various usage scenarios of the system for determining semantic points in a human-to-human conversation, according to various embodiments of the disclosure;

FIG. 9H illustrates various usage scenarios of the system for determining semantic points in a human-to-human conversation, according to various embodiments of the disclosure; and

FIG. 10 illustrates a process flow for determining semantic points in a human-to-human conversation, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this disclosure to “an aspect”, “another aspect” or similar language means that a particular feature, structure, or characteristic described in connection with the embodiment is included in at least one embodiment of disclosure. Thus, appearances of the phrase “in an embodiment”, “in another embodiment” and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The terms “multi-party conversation”, “human-to-human conversation”, and “conversation”, may be used interchangeably throughout the description. The terms “user device”, “device”, and “electronic device” along with their inherent variations may be used interchangeably throughout the description.

The disclosure is directed towards a method and a system for determining semantic points in a human-to-human conversation (HHC) based on dialogue turns, natural language (NL) attributes, transient states and one or more conversation nuances in the conversation.

Parameters such as dialogue turns, NL attributes, transient states and conversation nuances play a significant role in identifying semantic points in the HHC and determine an intended summary of the conversation.

In some embodiments, the method and system of the disclosure may enable advanced features in group conversation applications such as, semantic searching and displaying of important information, relevant dialogue recommendation, tracking conversation nuances and suggesting changes to the summary of the conversation.

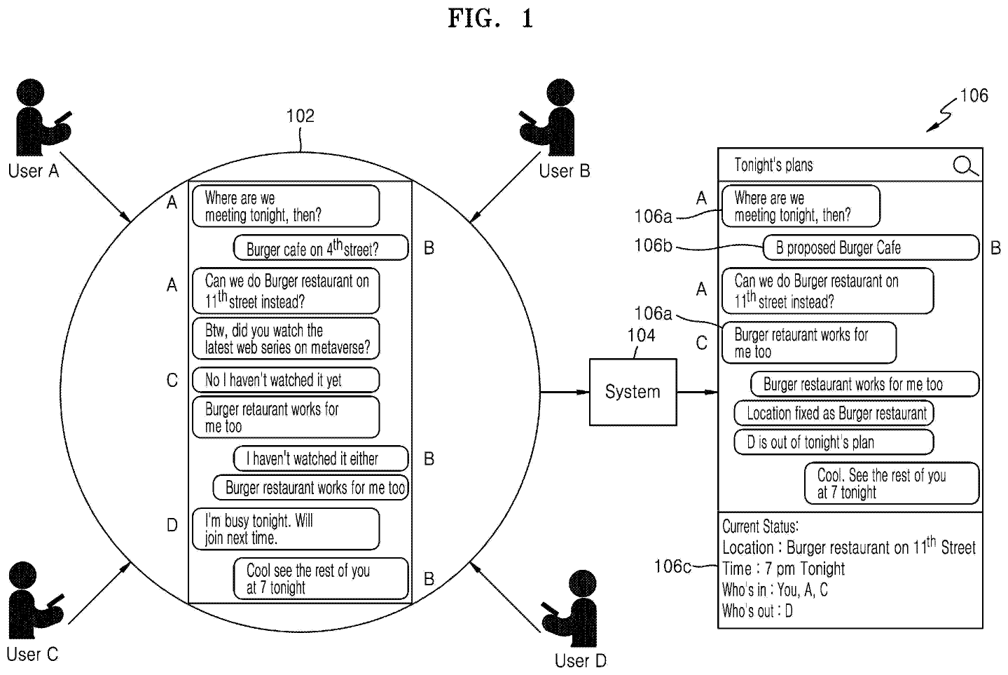

FIG. 1 illustrates an environment of a system for determining semantic points in a human-to-human conversation, according to an embodiment of the disclosure.

Referring to FIG. 1, it illustrates an environment 100 of a system 104 including a multi-party conversation 102 with multiple participants, namely user A, user B, user C and user D. In one embodiment, the multi-party conversation 102 may be implemented on a user device associated with each participant via any suitable social media messaging platform. The user device of the participant may include, but not limited to, a smartphone, a tablet, a laptop, a personal computer, a smart watch, a smart television, an IoT device, and any other electronic device configured to facilitate communication among users via a messaging platform. The multi-party conversation 102 refers to a human-to-human conversation, where participants may be discussing about one or more topics, for example, a meeting plan.

The multi-party conversation 102 may be received at the system 104, as an input from the respective user devices of the users A-D. In another embodiment, the system 104 may be a standalone entity located at a remote location and connected to the user devices of the participants of the multi-party conversation 102 via any suitable network. For example, the system 104 is implemented on a physical server (not shown in FIG. 1) of the messaging platform or in a cloud-based architecture. In another embodiment, the system 104 may be implemented within the respective user devices of one or more participants/users A-D.

The system 104 may be configured to receive the multi-party conversation 102 as the input and process the multi-party conversation 102 to determine one or more semantic points in the multi-party conversation 102. The multi-party conversation 102 may include a plurality of dialogue turns such as, user A's dialogue “Where are we meeting tonight, then?”, may be considered as one dialogue turn in the illustrated embodiment. The system 104 may also be configured to identify each of the dialogue turn from the multi-party conversation 102. Thereafter, the system 104 may be configured to determine one or more natural language (NL) attributes for each dialogue turn of the plurality of dialogue turns of the multi-party conversation 102. The NL attributes may be defined as building blocks of the dialogue turn (for example, a natural sentence). In an embodiment, the NL attributes may include grammar components such as, but not limited to, verbs or nouns. In another embodiment, the NL attributes may include, but not limited to, an intent, a dialogue act, a named entity, and a relation among the one or more NL attributes. The intent may indicate a purpose of the dialogue. The dialogue act may be defined as an utterance, in the context of a conversational dialog, serves a function in the dialogue. Types of dialogue acts may include a question, a statement, or a request for action. The named entities may refer to various nouns mentioned in a dialogue turn. In a further embodiment, any information that is extracted directly or indirectly from the natural language text may be attributed as NL attributes. For instance, in the illustrated embodiment of FIG. 1, the NL attributes corresponding to first dialogue turn, i.e., “Where are we meeting tonight, then?”, from user A may include intent as “schedule a meeting”, and a dialogue act as “request”, and named entity as “user A”.

Next, the system 104 may be configured to derive a transient state for each dialogue turn and one or more conversation nuances associated with the multi-party conversation 102 based on the one or more NL attributes and the one or more dialogue turns. In an embodiment, the transient state may refer to a state which is associated with each of the determined NL attributes. Based on the context of the multi-party conversation, the transient states may be indicative of a target memory to which an NL attribute must transition to. In some other embodiments, the transient states may also be an indicative of lifetime of the NL attributes. For example, the transient state included, but not limited to, confirm, temporary and ignore. The conversation nuances may be defined as categories or labels which reflect a level of uncertainties in human conversation. The examples of conversation nuances and/or labels may include, but not limited to, request information, suggestion, alternative suggestion, agreement, denial, and conclusion. For instance, in the illustrative embodiment of FIG. 1, for the first dialogue turn, the transient state of the action “schedule meeting” may be “confirm” and the conversation nuance may be “request information.” Similarly, for a second dialogue turn “Burger restaurant on 4th street?” by user B, the transient state for dialogue turn may be “temporary” and conversation nuance may be “suggestion”. In a similar manner, the system 104 may identify the transient state and the conversation nuance for each of the dialogue turn in the multi-party conversation 102. Therefore, in an embodiment, deriving the transient state for each dialogue turn may include assigning one of a temporary, confirmed, and ignored labels to each of the one or more NL attributes based on the one or more dialogue turn.

The system 104 may be configured to perform each of the above-mentioned steps after each dialogue turn in the multi-party conversation 102 and dynamically store information associated with the multi-party conversation 102 based on the one or more NL attributes, the transient states, and the one or more conversation nuances associated with each dialogue turn. Thereafter, the system 104 may be configured to determine one or more semantic relations and associated dialogue timelines within the multi-party conversation 102 based on the dynamically stored information. The system 104 may also be configured to generate the semantic points corresponding to the determined one or more semantic relations and the associated dialogue timelines.

Based on the information relating to semantic points, semantic relations, and associated dialogue timelines, the system 104 may enable features such as semantic searching, summarization, response suggestion, alert generation, for a user in an effective and efficient manner.

For example, if a user B searches for “Tonight's plan”, the system 104 is configured to generate an output 106 illustrating important and relevant dialogues 106a from user B, relevant semantic points 106b and overall conclusion 106c of the multiple dialogue turns within the multi-party conversation 102.

Further, the illustrated embodiments are in nature and the system 104 may be implemented to minimize chats in chat rooms and/or of a messaging platform, dialogue suggestion based on high level semantic points, navigation and extraction of specific information based on semantic point-based search or navigating to a region of interest in a recorded video.

Further, the system 104 may be configured to enable quicker and easier chat consumption experience by enabling user(s) to easily track a specific topic in the multi-party conversation 102, enabling user to easily find and navigate to a specific piece of information discussed in the multi-party conversation 102, and providing an easily readable compact view of an overall conversation with key information marked, while still providing an overall flow and timeline of the conversation.

In other embodiments, the system 104 may also be configured to enable reliable and smart Artificial Intelligence (AI) assistance for users by correctly understanding intent parameters from the multi-party conversation 102, providing properly timed proactive assistance in intent completion, and providing relevant “Suggested replies” to reduce an amount of required cognition and user effort.

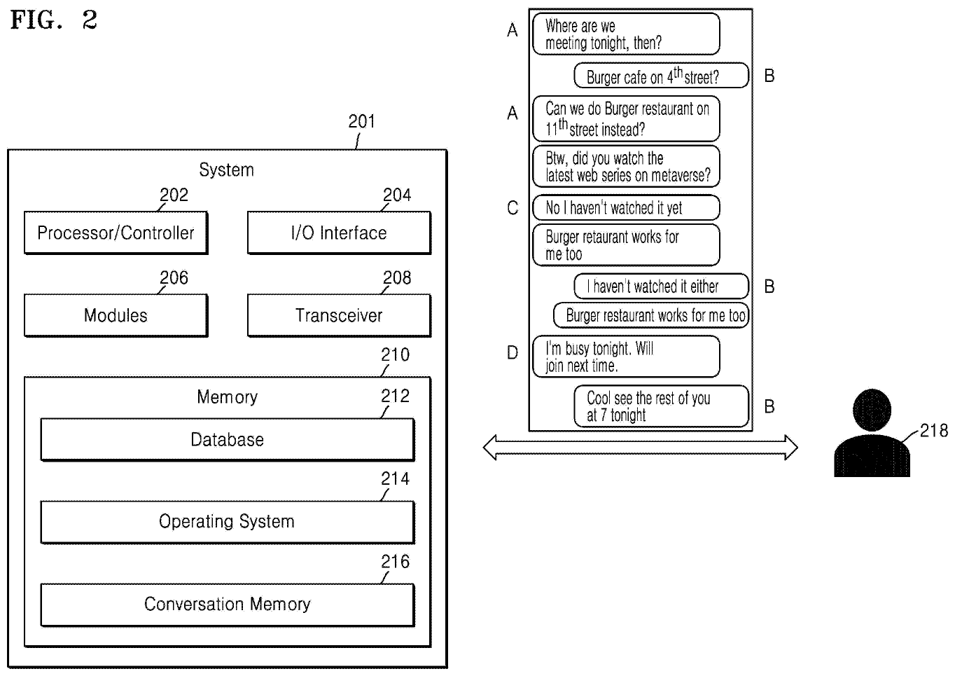

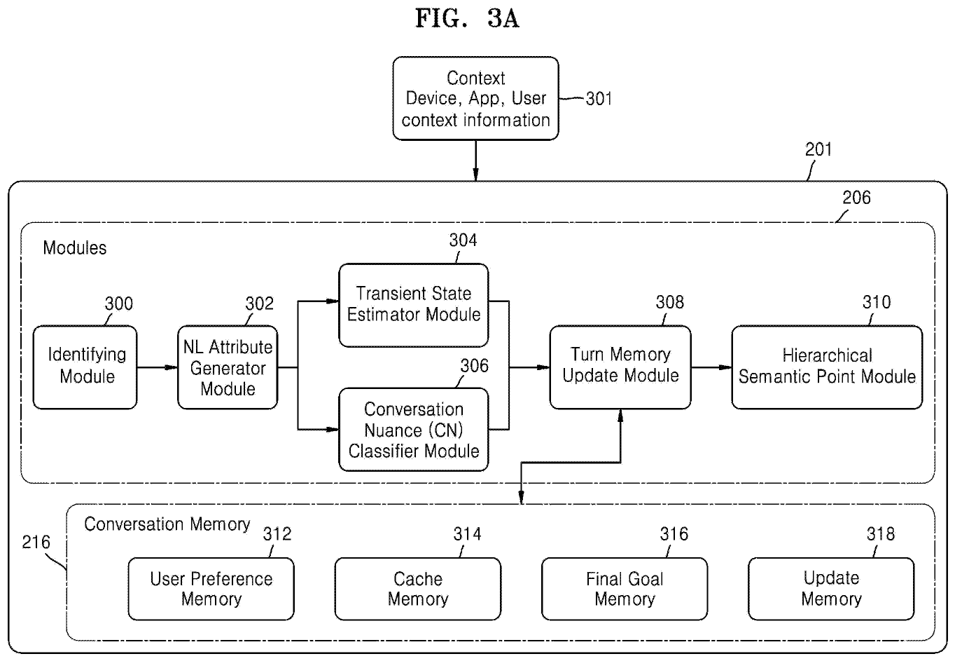

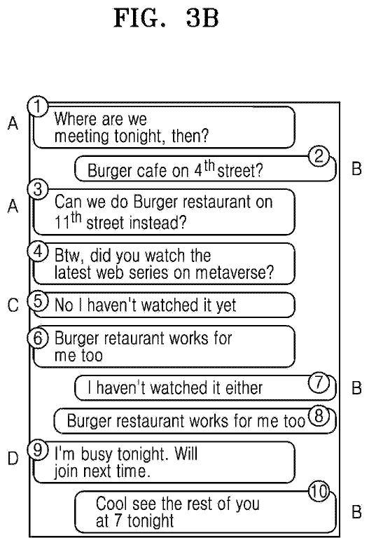

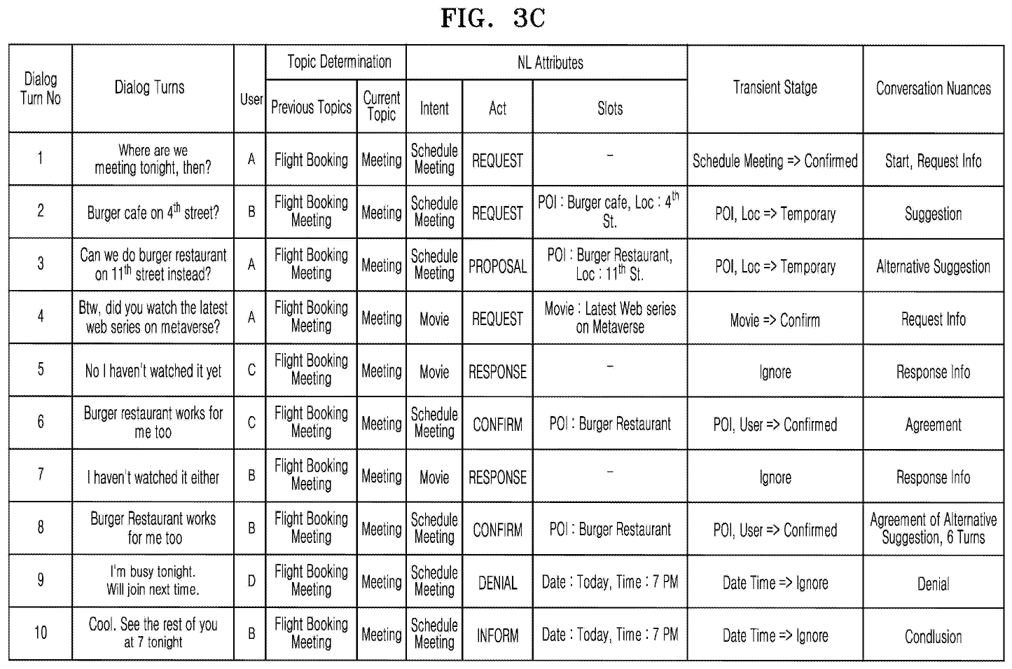

The system 104 may be configured to achieve the above-mentioned technical advantages by performing one or more operations explained in detail at least referring to FIGS. 2, 3A, 3B and 3C.

FIG. 2 illustrates a schematic block diagram of a system for determining semantic points in a human-to-human conversation, according to an embodiment of the disclosure.

Referring to FIG. 2, the system 201 may correspond to the system 104, as illustrated in FIG. 1. In another embodiment, the system 201 may be included within an electronic/user device associated with a user involved in the human-to-human conversation. In another embodiment, the system 201 may be configured to operate as a standalone device or a system based in a server/cloud architecture communicably coupled to the electronic device. Examples of the electronic device may include, but not limited to, a mobile phone, a smart watch, a laptop computer, a desktop computer, a Personal Computer (PC), a notebook, a tablet, a mobile phone, and or any other smart device configured to support human-to-human conversation via a messaging platform as discussed throughout this disclosure.

The system 201 may be configured receive and process a human-to-human conversation to determine corresponding semantic points. The system 201 may include a processor/controller 202, an Input/Output (I/O) interface 204, one or more modules 206, a transceiver 208, and a memory 210.

In an embodiment, the processor/controller 202 may be operatively coupled to each of the I/O interface 204, the modules 206, the transceiver 208 and the memory 210. In one embodiment, the processor/controller 202 may include at least one data processor for executing processes in Virtual Storage Area Network. The processor/controller 202 may include specialized processing units such as, integrated system (bus) controllers, memory management control units, floating point units, graphics processing units, digital signal processing units, etc. In one embodiment, the processor/controller 202 may include a central processing unit (CPU), a graphics processing unit (GPU), or both. The processor/controller 202 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 202 may execute a software program, such as code generated manually (i.e., programmed) to perform the desired operation.

The processor/controller 202 may be disposed in communication with one or more input/output (I/O) devices via the I/O interface 204. The I/O interface 204 may employ communication code-division multiple access (CDMA), high-speed packet access (HSPA+), global system for mobile communications (GSM), long-term evolution (LTE), worldwide interoperability for microwave access (WiMax), or the like, etc.

Using the I/O interface 204, the system 201 may communicate with one or more I/O devices, specifically, the user devices associated with the human-to-human conversation. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc. In an embodiment, the system 201 may communicate with the electronic device associated with the user using the I/O interface 204.

The processor/controller 202 may be disposed in communication with a communication network via a network interface. In a further embodiment, the network interface may be the I/O interface 204. The network interface may connect to the communication network to enable connection of the system 201 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, institute of electrical and electronics engineers (IEEE) 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, a voice assistant device may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In an embodiment, the processor/controller 202 may receive the human-to-human conversation from at least one user 218. In some embodiments where the system 201 is implemented as a standalone entity at a server/cloud architecture, the human-to-human conversation may be received from a user device associated with the user 218. Further, even though only one user 218 is depicted in FIG. 2, it may be apparent that the system 201 may be configured to receive human-to-human conversation from multiple user devices engaged in a group conversation as discussed in conjunction with FIG. 1. The processor/controller 202 may execute a set of instructions on the received human-to-human conversation information to identify the corresponding semantic points in said conversation. The processor/controller 202 may implement various techniques such as, but not limited to, Natural Language Processing (NLP), data extraction, Artificial Intelligence (AI), and so forth to achieve the desired objective.

In some embodiments, the memory 210 may be communicatively coupled to the at least one processor/controller 202. The memory 210 may be configured to store data, instructions executable by the at least one processor/controller 202. In one embodiment, the memory 210 may communicate via a bus within the system 201. The memory 210 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the processor/controller 202. In alternative examples, the memory 210 is separate from the processor/controller 202, such as a cache memory of a processor, the system memory, or other memory. The memory 210 may be an external storage device or database for storing data. The memory 210 may be operable to store instructions executable by the processor/controller 202. The functions, acts or tasks illustrated in the figures or described may be performed by the programmed processor/controller 202 for executing the instructions stored in the memory 210. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In some embodiments, the modules 206 may be included within the memory 210. The memory 210 may further include a database 212 to store data. The one or more modules 206 may include a set of instructions that may be executed to cause the system 201 to perform any one or more of the methods/processes disclosed herein. The one or more modules 206 may be configured to perform the steps of the disclosure using the data stored in the database 212, to determine semantic points in a human-to-human conversation as discussed herein. In an embodiment, each of the one or more modules 206 may be a hardware unit which may be outside the memory 210. Further, the memory 210 may include an operating system 214 for performing one or more tasks of the system 201, as performed by a generic operating system in the communications domain. The memory 210 may also include a conversation memory 216 configured to store the human-to-human conversation and associated parameters at each dialogue turn. The associated parameters of the human-to-human conversation may include, but not limited to, a user preference, an intent, an act, a transient state, a conversation nuance and so forth, which are associated with each of the dialogue turn in the human-to-human conversation. The transceiver 208 may be configured to receive and/or transmit signals to and from the electronic device associated with the user. In one embodiment, the database 212 may be configured to store the information as required by the one or more modules 206 and the processor/controller 202 to perform one or more functions for determining semantic points in a human-to-human conversation.

In an embodiment, the I/O interface 204 may enable input and output to and from the system 201 using suitable devices such as, but not limited to, display, keyboard, mouse, touch screen, microphone, speaker and so forth.

Further, the disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor/controller 202 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 201 may be physical or may be established wirelessly. The network may alternatively be directly connected to the bus. For the sake of brevity, the architecture and standard operations of the operating system 214, the memory 210, the database 212, the processor/controller 202, the transceiver 208, and the I/O interface 204 are not discussed in detail.

FIG. 3A illustrates a schematic block diagram of modules and a conversation memory of a system for determining semantic points in a human-to-human conversation, according to an embodiment of the disclosure.

FIGS. 3B and 3C illustrate an illustration of a human-to-human conversation for determining semantic points, according to another embodiment of the disclosure.

Referring to FIGS. 3A, 3B, and 3C, modules 206 and the conversation memory 216 involved in implementing the desired objective of the disclosure are illustrated. The illustrated embodiment of FIG. 3A depicts a sequence flow of process among the modules 206 for determining the semantic points in the human-to-human conversation. The process flow of FIG. 3A may be explained in conjunction with FIGS. 3B and 3C. The modules 206 may include, but not limited to, a natural language (NL) attribute generator module 302, a transient state estimator module 304, a conversation nuance (CN) classifier module 306 (also referred as “the CN module 306”), a turn memory update module 308 and a hierarchical semantic point module 310. The modules 206 may be implement by way of suitable hardware and/or software applications.

In an embodiment, the system 201 may be configured to receive a human-to-human conversation (HHC) along with a context information 301, as initial inputs. In a further embodiment, the HHC and the context information 301 may be suitably converted into textual format before inputting to the system 201. For instance, if the human-to-human conversation is performed in a media format such as, audio or video format, the conversation may be first converted into textural format. The human-to-human conversation may be performed via any suitable platform, such as, but not limited to, a messaging device and/or a software mobile application. The context information 301 may include external information related to the HHC. The context information may be received from the user device and/or external sources such as, but not limited to, social networking services, web search engines, or websites. For example, the context information includes information from user device applications such as, navigation applications, web browsers, messaging applications, sensors, and device contacts. Similarly, the context information from external sources may include user profile information from social network services or browser history of the user, which may be attributed to context. In an embodiment, the HHC and the context information 301 may be passed through the NL attribute generator module 302, as inputs. The NL attribute generator module 302 may be configured to process the received HHC and the context information 301 to identify each of the dialogue turns in the received conversation and generate one or more NL attributes corresponding to each dialogue turn. In some alternative embodiment, an identifying module 300 may be configured to identify the human-to-human conversation, comprising a plurality of dialogue turns, on an electronic device. The NL attribute generator module 302 may be configured to implement any suitable technology as, but not limited to, Natural Language Processing (NLP), Natural Language Understanding (NLU), and Natural Language Generation (NLG), Artificial Intelligent (AI) and so forth, to identify dialogue turns and associated NL attributes from the HHC and the context information 301.

In an embodiment, the NL attribute generator module 302 may be configured to perform topic determination to determine a previous topic and a current topic from the context information 301. The topics may include, but not limited to, flight booking, meeting, and so forth. Further, the NL attributes determined by the NL attribute generator module 302 may include an intent of the conversation, an act of the conversation and slot information of the conversation. The intent may refer to a reason for conversation to take place. For example, when we converse with a friend to meet for dinner, the intent is to have dinner with him/her. Further examples of the intent of conversation may include, but not limited to, schedule meeting, movie plan, travel plan and so forth. The act of the conversation may categorize the dialogue turns in a given conversation to indicate if the dialogue turn is a request, response, proposal, confirmation, denial etc. The slot may refer to a named entity identified in the dialogue turn. For example, Burger King in the dialogue turn “Lets meet at Burger King” is a slot. Further examples of the slot information of the conversation may include, location, point of interest, date, time and so forth. In an embodiment, a dialogue turn may be associated with a single act and may include one or more slot information.

Thereafter, the determined one or more NL attributes corresponding to each of the dialogue turns may be passed through the transient state estimator module 304 and the CN classifier module 306. The transient state estimator module 304 may be configured to derive a transient state corresponding to each dialogue turn based on the corresponding NL attributes. The transient states derived by the transient state estimator module 304 may include state information such as, but not limited to, confirmed, temporary and ignore. For example, the transient state estimator module 304 determines transient states as “meeting is confirmed” and “location is temporary”. The transient state estimator module 304 may correlate the one or more NL attributes to drive at the corresponding transient state. For example, for an act of proposal and a slot information of location, the transient state estimator module 304 determines the corresponding transient state as the location is temporary.

The CN classifier module 306 may be configured to derive one or more conversation nuances associated with the conversation based on the corresponding NL attributes. The conversation nuances may include information, such as, but not limited to, start, request info, suggestion, alternative suggestion, agreement, agreement of alternative suggestion, denial, conclusion and so forth. For instance, for an act of confirmation, and slot information indicating point of interaction (POI) as Burger restaurant, the conversation nuance may be determined as agreement. Therefore, the CN classifier module 306 may be configured to establish a relationship between the one or more NL attributes to derive the corresponding conversation nuances. Further, the conversation nuances may be categorized into three broader categories of positive, negative, and neutral, each indicating an intent of the various users with respect to each dialogue turn.

The derived transient state and conversation nuances corresponding to the dialogue turns may be passed through the turn memory update module 308. The turn memory update module 308 may be configured to dynamically update a user preference memory 312, a cache memory 314, and a final goal memory 316 based on the received transient states and conversation nuances. The user preference memory 312, the cache memory 314, and the final goal memory 316 are a part of the conversation memory 216. In an embodiment, the user preference memory 312 may corresponds to a user, whereas the cache memory 314 and the final goal memory 316 may corresponds to a topic of conversation. In an embodiment, the turn memory update module 308 may be configured to transit information between the cache memory 314 and the final goal memory 316 based on the conversation nuances associated with dialogue turns. Specifically, the three categories of CN may be responsible to transition information from the cache memory 314 to the final goal memory 316 or vice-versa. In an embodiment, a neutral value of CN may indicate no change to the final goal memory 316, a positive value of CN may indicate that information should be moved from the cache memory 314 to the final goal memory 316, a negative value of CN may indicate that information should be moved from the final goal memory 316 to the cache memory 314. In another embodiment, the turn memory update module 308 may transit the information between the cache memory 314 and the final goal memory 316 based on above-defined rules. Further, the turn memory update module 308 may be configured to update the user preference memory 312 with information corresponding to each of the dialogue turn. In an embodiment, the turn memory update module 308 may be configured to update the cache memory 314 with the information stored in the user preference memory 312 based on the transient state associated with each dialogue turn. In an embodiment, the turn memory update module 308 may also be configured to utilize the NL attributes to update the user preference memory 312, the cache memory 314, and the final goal memory 316. Therefore, the turn memory update module 308 may be configured to dynamically store information associated with the human-to-human conversation after each dialogue turn based on one or more NL attributes and the transient state associated with each of the dialogue turn, and the conversation nuances associated one or more dialogue turns of the conversation. Further, the turn memory update module 308 may be configured to create an update timeline 318 based on the dynamically stored information. The update timeline 318 may include update points associated with each dialogue turn. Further, the update points may include information associated with the one or more NL attributes, the transient state, conversation nuance labels, NL representation of the update point along with one or more variations. In an embodiment, the turn memory update module 308 may be configured to generate dialogue timelines based on one or more update points.

The update timeline 318 may be fed to the hierarchical semantic point module 310. In other embodiment, the information updated by the turn memory update module 308 may be passed through the hierarchical semantic point module 310. The hierarchical semantic point module 310 may be configured to determine one or more semantic relations and associated dialogue timelines within the human-to-human conversation based on the dynamically stored information. In a further embodiment, the semantic relations may be identified using the transient states associated with each dialogue turn. Further, the semantic relations may indicate one or more semantic points and the corresponding dialogue turns. Further, the hierarchical semantic point module 310 may be configured to generate the semantic points corresponding to the determined one or more semantic relations and the associated dialogue timelines within the human-to-human conversation. In an embodiment, the semantic relations may be used in generating hierarchical semantic points (HSP). For instance, in the process of generating HSPs, two or more semantic points (SP) from same or different levels of semantic points may be compared to establish common characteristic. The determined common characteristic may be termed as semantic relation. In an embodiment, the hierarchical semantic point module 310 may be configured to generate one or more hierarchical semantic point across a plurality of levels of the conversation based on the update points in the update timeline 318. For instance, update information from each dialogue turn may be marked as level 0 Semantic Point (SP). Level 0 SPs may be combined to generate level 1 SP. Further, level 1 and level 0 SPs may be combined to generate level 2 SP. Further, level 0-2 SPs may be combined in pairs to generate level 3 SP and so on. Further, the hierarchical semantic points module 310 may be configured to combine the generated one or more hierarchical semantic points across the plurality of levels to generate more high-level semantic points. Moreover, the hierarchical semantic point module 310 may be configured to associate one or more NL attributes based on the combined one or more semantic points to represent the high-level semantic points.

In some embodiments, the hierarchical semantic point module 310 may also be configured to determine an NL representation along a range of the associated one or more dialogue turns for a user of the HHC based on the generated semantic points. In an embodiment, the NL representation may refer to an outcome, i.e., a summary associated with the one or more dialogue turns which are generated based on the generated semantic points. Further, the “range” may be associated with the number of dialogue turns which may be used to determine the NL representation. Further, the hierarchical semantic point module 310 may be configured to determine at least one dialogue turn from the one or more dialogue turns of the human-to-human conversation that contributes directly to the semantic points based on the semantic points and one or more update points associated with dialogue turns. Moreover, the hierarchical semantic point module 310 may be configured to determine a compressed version of the one or more dialogue turns based on the semantic points and the at least one dialogue turn. The compressed version is displayed on a user interface for a user of the human-to-human conversation.

The modules 206 may be implemented by any suitable hardware and/or set of instructions. Further, the sequential flow illustrated in FIG. 3A is in nature and the embodiments may include addition/omission of steps as per the requirement. In some embodiments, the one or more operations performed by the modules 206 may be performed by the processor/controller 202 based on the requirement.

FIGS. 3B and 3C illustrate an illustration of a human-to-human conversation for determining semantic points. Specifically, FIGS. 3B and 3C illustrate an example of a human-to-human conversation include ten dialogue turns from four users namely, user A, user B, user C and user D. Further, the various output generated by each of the NL attribute generator module 302, the transient state estimator module 304, and the CN classifier module 306 corresponding to each of the dialogue turn as been clearly disclosed in illustrated Table. Therefore, FIGS. 3B and 3C clearly illustrate operation of the system 201 on a human-to-human conversation.

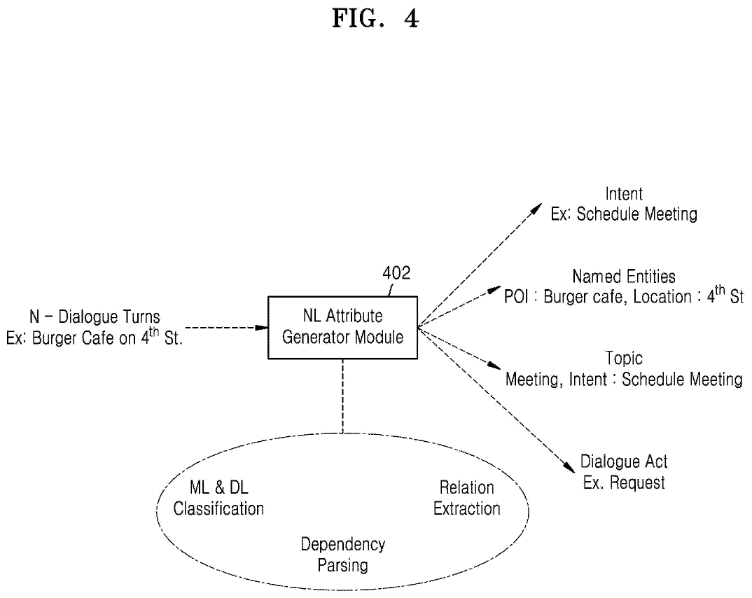

FIG. 4 illustrates an embodiment of a natural language (NL) attribute generator module, according to an embodiment of the disclosure.

Referring to FIG. 4, a NL attribute generator module 402 may corresponds to the NL attribute generator module 302, as shown in FIG. 3A. As illustrated, the NL attribute generator module 402 may receive a plurality of dialogue turns which are part of a human-to-human conversation. Example of one such dialogue turn may be “Burger Cafe on 4th St.”. The NL attribute generator module 402 may process the received dialogue turn using techniques such as, but not restricted to, machine learning (ML) and deep learning (DL) based classification, a relation extraction, dependency parsing and so forth to determine the NL attributes. Further, the NL attributes may include an intent, named entities, topic, and dialogue act and so forth. For instance, in the illustrated embodiment for the dialogue “Burger Cafe on 4th St.”, the NL attribute generator module 402 may determine intent as “schedule meeting”, named entities as “POI: Burger cafe, Location: 4th St.”, topic as “Meeting, Intent: Schedule Meeting” and dialogue act as “Request”. In general, a HHC may start with an intent and many times there may be several such sub-conversations with a different intent. Thus, the NL attribute generator module 402 may be configured to categorize the group of dialogues within a conversation with a specific intent and identify the corresponding NL attributes. In some embodiments, the output of the NL attribute generator module 402 may be provided as feedback input in next determination of NL attributes.

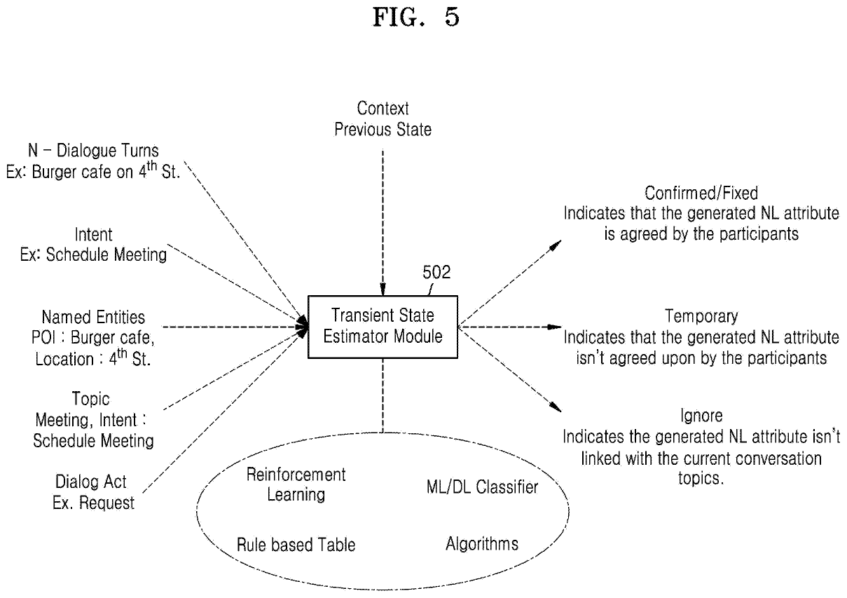

FIG. 5 illustrates an embodiment of a transient state estimator module, according to an embodiment of the disclosure.

Referring to FIG. 5, a transient state estimator module 502 may correspond to the transient state estimator module 304, as shown in FIG. 3A. The transient state estimator module 502 may be configured to receive a plurality of dialogue turns which are part of a HHC along with the NL attributes determined by the NL attribute generator module 402, 302. The transient state estimator module 502 may also be configured to receive context information indicating a previous state of the dialogue turn in the HHC. The transient state estimator module 502 may be configured to process the received information using techniques such as, but not limited to, reinforcement learning, ML and DL classification, rule-based tables, and various models to determine the transient state of a dialogue turn as confirmed and/or fixed, temporary, or ignore. In another embodiment, the confirmed and/or fixed transient state may indicate that the generated NL attributes are agreed by the participants of the HHC, the temporary transient state may indicate that the generated NL attributes are not agreed upon by the participants and the ignore transient state may indicate the generated NL attributes are not linked with a current conversation topic. Further, the transient states determined by the transient state estimator module 304 may be used to update the user preference memory 312 and the cache memory 314.

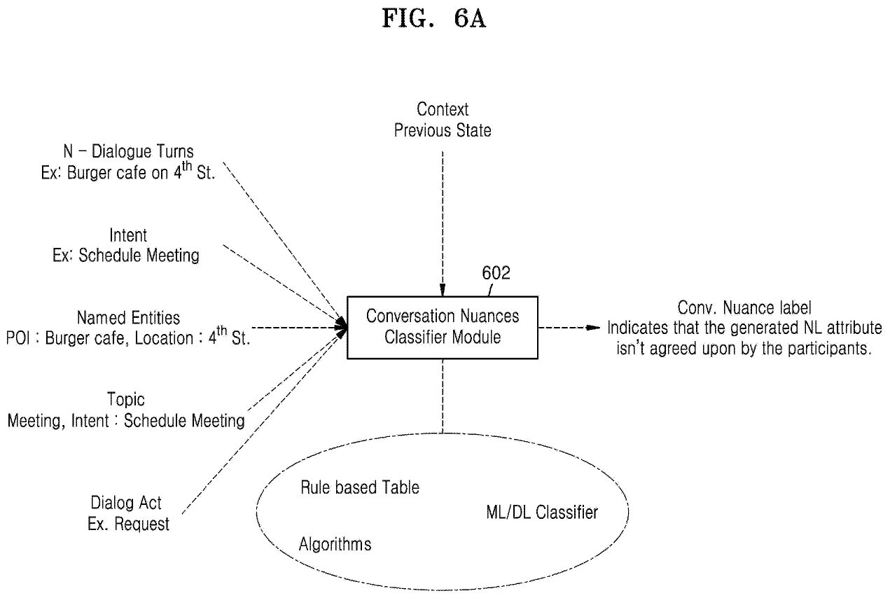

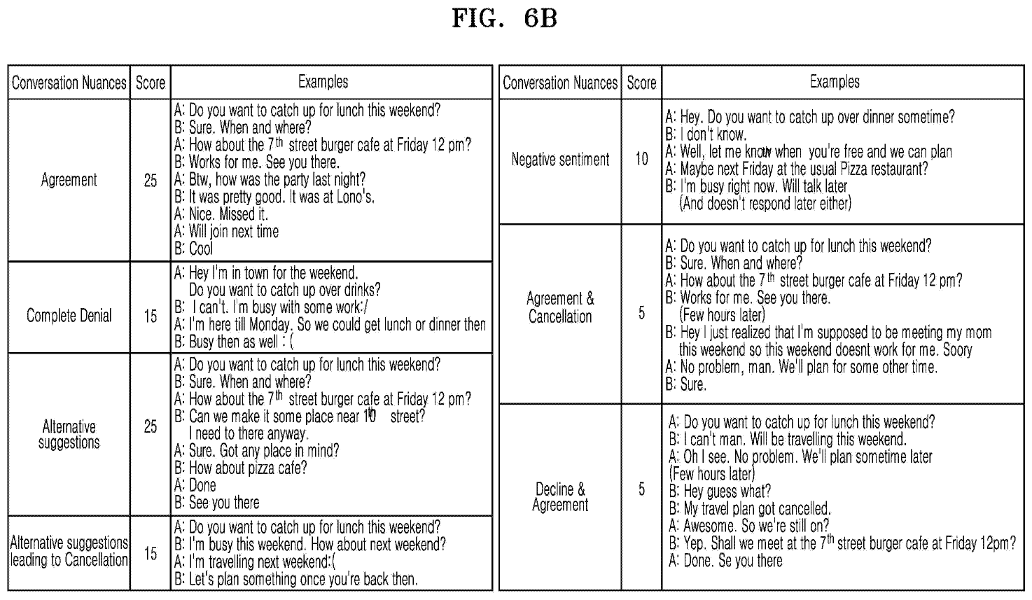

FIGS. 6A and 6B illustrate an embodiment of a conversation nuances (CN) classifier module, according to various embodiments of the disclosure.

Referring to FIGS. 6A and 6B, a CN classifier module 602 may correspond to the CN classifier module 306, as shown in FIG. 3A. The CN classifier module 602 may receive a plurality of dialogue turns which are part of a HHC along with the NL attributes determined by the NL attribute generator module 402, 302. The CN classifier module 602 may also be configured to receive context information indicating a previous state or a previously identified conversation nuance level as an input. Thereafter, the CN classifier module 602 may be configured to process the received information using techniques such as, rule-based tables, ML and/or DL classification and various other models to determine a corresponding conversation nuance label for each dialogue turn. In an embodiment, the conversation nuance label may indicate the generated NL attributes are not agreed upon by the participants of the conversation. Specifically, the conversation nuances may provide a high-level understanding of the user's intension about one or more NL attributes associated with the dialogue turns of the HHC. Further, the conversance nuances determined by the CN classifier module 602 may be used to update cache memory 314.

Moreover, the conversation nuances may be broadly classified into three classes namely, a positive CN, a negative CN, and a neutral CN. The positive CN may include conversation nuances such as agreements, disagreement and agreement, positive sentiments, and emotions etc. The negative CN may include conversation nuances such as disagreements, agreement and disagreement, negative sentiments, and emotions, etc. Further, the Neutral CN may include conversation nuances such as suggestion, questions, and requests. In an embodiment, the positive CN may be responsible for transmitting information from the cache memory 314 to the final goal memory 316. The negative CNs may be responsible for transmitting information from the final goal memory 316 back to the cache memory 314. The neutral CNs may not alter any information already stored within any of the cache memory 314 or the final goal memory 316. However, the neutral CNs may be responsible for creating a new instance in the cache memory 314. In some embodiments, the conversation nuances may be combined with other emotional attributes of a human.

Further, an identification of the conversation nuances may help in generating accurate understanding, summary, and dialogue suggestion. Further, FIG. 6B illustrates a table with conversation nuances associated with different HHC conversation. FIG. 6B also illustrates a component “score” which may also be generated by the CN classifier module 602 to effectively generate an accurate understanding, summary, and dialogue suggestion. The score associated with the conversation nuances may be based on one or more NL attributes associated with dialogue turns.

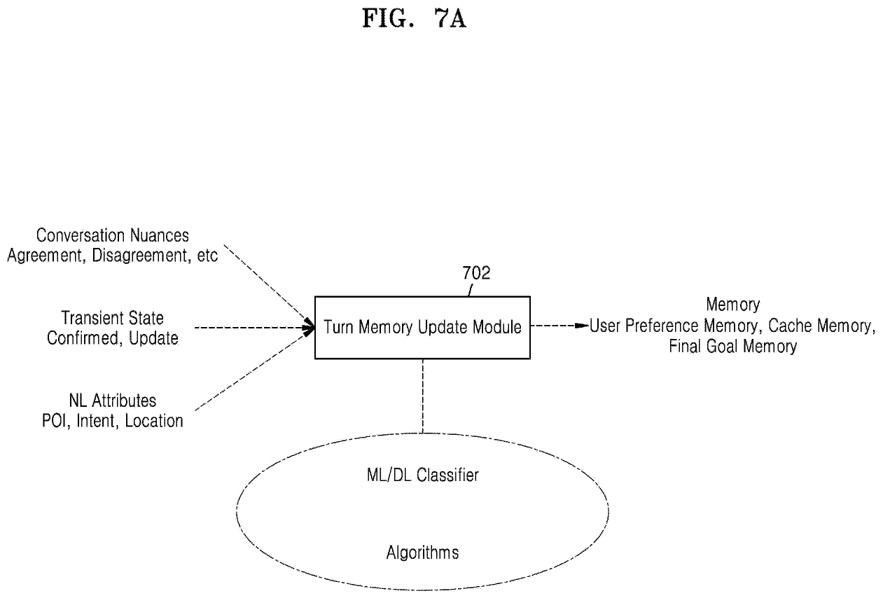

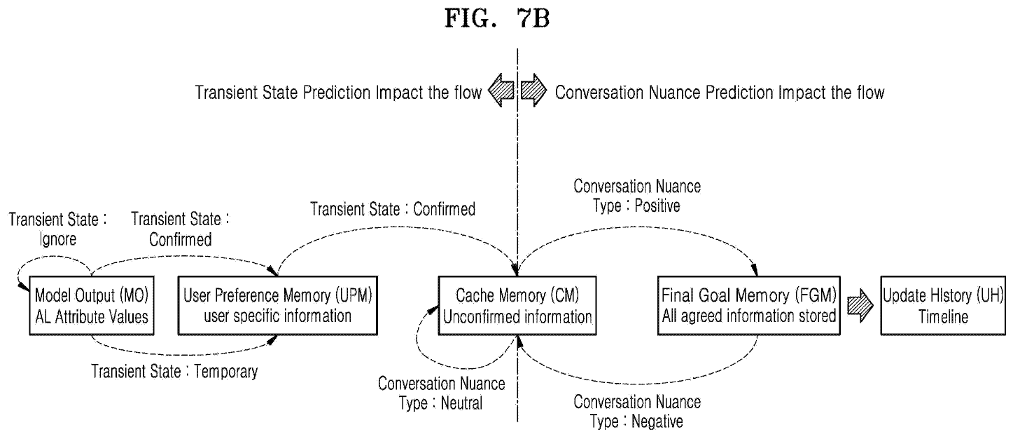

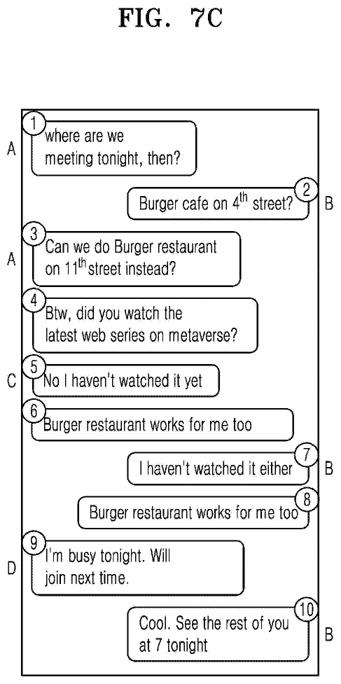

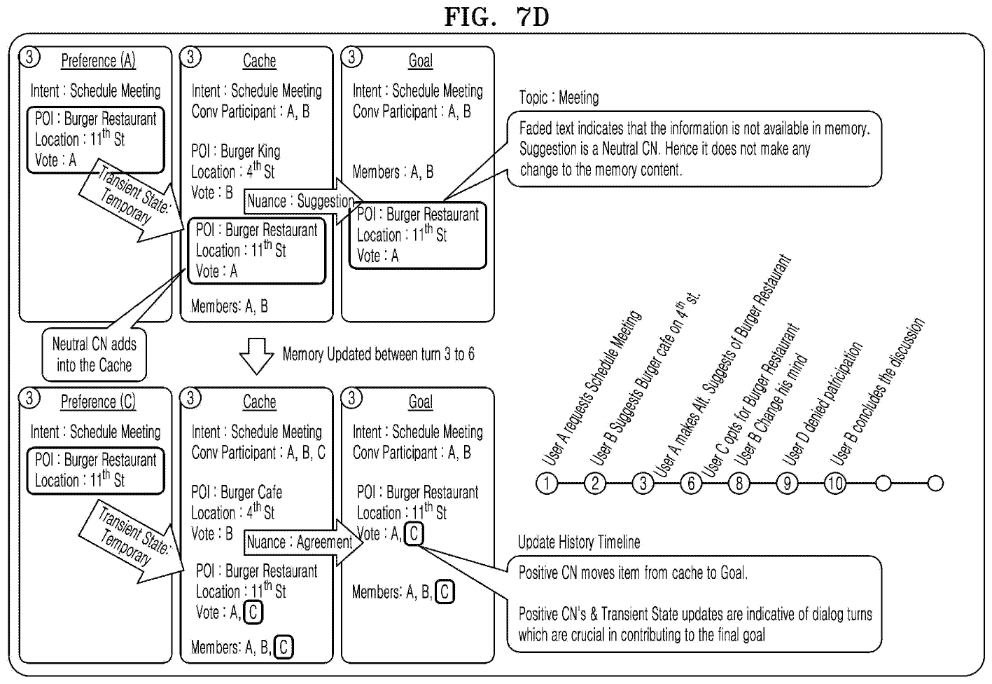

FIGS. 7A, 7B, 7C, and 7D illustrate an embodiment of a turn memory update module, according to various embodiments of the disclosure.

Referring to FIG. 7A, a turn memory update module 702 may corresponds to the turn memory update module 308, as shown in FIG. 3A. The turn memory update module 702 may take conversation nuances, the transient state, and NL attributes as inputs to update one or more memories. The turn memory update module 702 may be configured utilize technologies such as, but not limited to, ML and/or DL classification and/or various other models to update the memories based on received information. In an embodiment, the turn memory update module 702 may be configured to make memory update judgements based on the values of transient state and conversation nuances class labels. The turn memory update module 702 may be configured to govern the movement of NL attributes and other related information among different memory namely, the user preference memory 312, the cache memory 314, and the final goal memory 316. For instance, the turn memory update module 702 may be configured to utilize transient state to update NL attribute values in the user preference memory 312 and/or the cache memory 314. Further, the turn memory update module 702 may be configured to utilize conversation nuances label information to manage a movement of information between the cache memory 314 and the final goal memory 316.

Referring to FIG. 7B, flow of information among different memories, which may be managed by the turn memory update module 702 is illustrated. Initially, a multi-party conversation along with associated NL attribute values may be fed to architectural pipe, which is illustrated as “Model Output (MO)”. Thereafter, the turn memory update module 702 may utilize the determined transient state to update the User Preference Memory (UPM). For instance, if the transient state is “Ignore”, the MO values are unused. If the transient state is “Temporary”, then the MO values are just updated into the UPM. If the transient state is “Confirmed”, then the MO values are updated both into UPM & cache Memory (CM). Thereafter, the turn memory update module 702 may be configured to use determined conversation nuances categorized in three categories namely, Positive CN, negative CN and neutral CN. For neutral type of CNs, the turn memory update module 702 may leave the information in CM without further processing. For positive type of CNs the turn memory update module 702 may be configured to move the turn MO from CM to final goal memory (FGM). For negative type of CNs, the turn memory update module 702 may move the turn MO back to CM from FGM. In an embodiment, NL attribute values may be represented as MO, user specific information may be stored in UPM, unconfirmed information may be stored in CM and all agreed information may be stored in FGM. Moreover, any update to UPM, CM, and FGM are stored into update history (UH) timeline (also referred as “update timeline”) which may be used to semantic point determination.

Referring to FIGS. 7C and 7D, an example of human-to-human conversation and flow of transfer of information and/or NL attributes into different memories by the turn memory update module 702 is illustrated. Further, FIGS. 7C and 7D also illustrate an update timeline generated based on the flow of transfer of information in different memory. Specifically, FIGS. 7C and 7D illustrate an HHC conversation among four participants and their corresponding dialogue turns. In an embodiment, a user preference memory may be associated with each of participant.

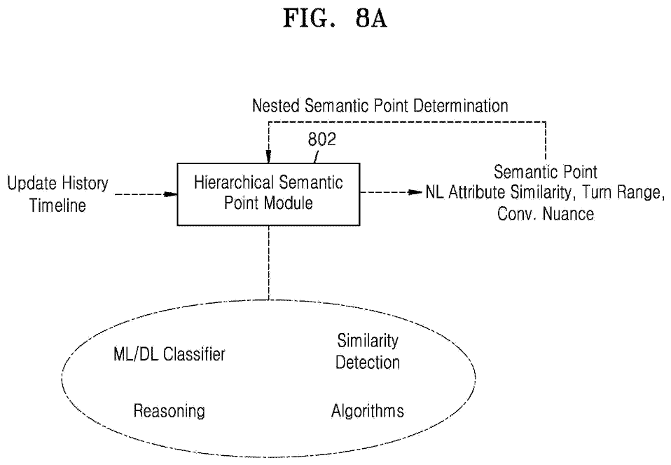

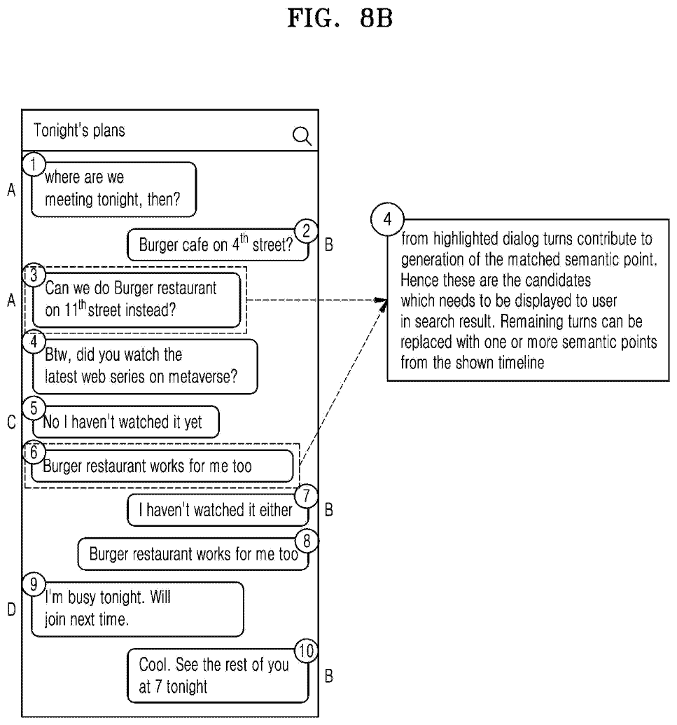

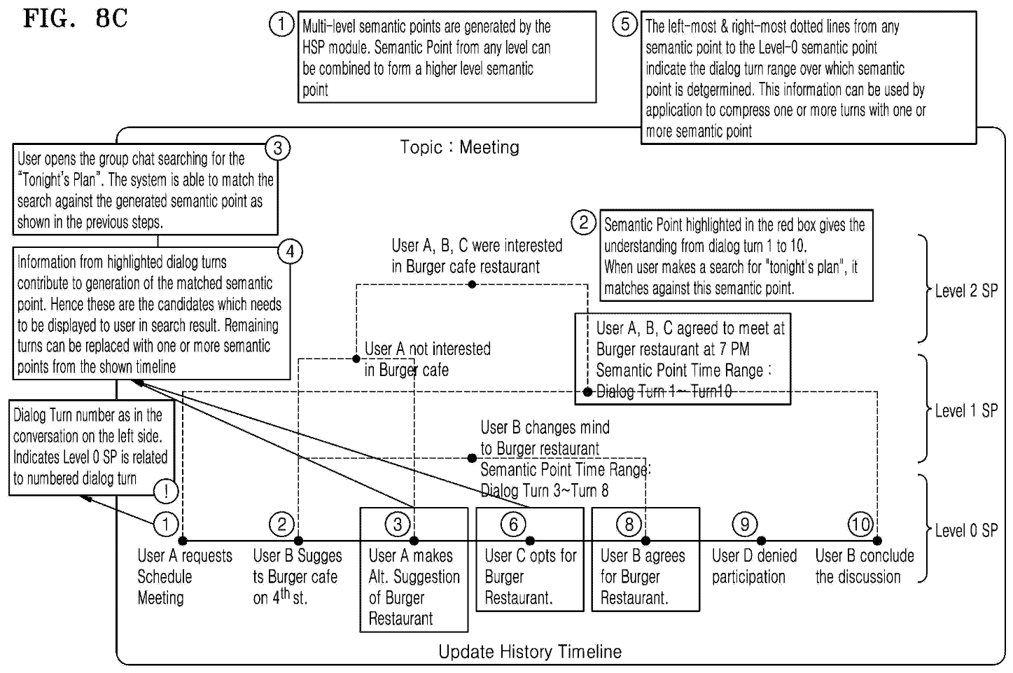

FIGS. 8A, 8B, and 8C illustrate an embodiment of a hierarchical semantic point (HSP) module, according to various embodiments of the disclosure.

Referring to FIGS. 8A, 8B, and 8C, a HSP module 802 (interchangeably referred to as “the semantic point module 802” and/or “HSP module 802”) may correspond to the hierarchical semantic point module 310, as shown in FIG. 3A.

The HSP module 802 may receive update timeline information as an input. The HSP module 802 may be configured to process the inputted information using techniques such as, but not limited to, ML and/or DL classification, similarity detection, reasoning, and/or various other models to generate semantic points. The semantic points may be based upon NL attribute similarity, dialogue turn range, and conversation nuances.

In another embodiment, any update to the final goal memory 316 may be stored into the update timeline 318. The HSP module 802 may be configured to perform similarity check between each update in the update history timeline points stored in the update timeline 318. The HSP module 802 may also determine a similarity between the NL attributes from the semantic points of same and/or NL attributes from the semantic points across different levels. Further, the HSP module 802 may associate a dialogue turn range with the semantic point for each determined similarity. Further, In an embodiment, the NL Attribute similarity results may be passed to the NL attribute generator module 302 to generate a description for the semantic point. The NL attribute generator module 302 may generate various variations for the semantic point description. The HSP module 802 may utilize reasoning models to generate more high-level semantic points. The generated semantic points may be used for applications, such as, but not limited to, compressed display of dialogue turn, searching high-level understanding of conversation and so forth. The HSP module 802 may also be configured to analyze various topics within a same HHC conversation or multiple HHC conversations. FIGS. 8B and 8C illustrate determination and interaction of various crucial semantic points in a HHC conversation by the HSP module 802. In the illustrated embodiment, the HSP module 802 may determine three level of semantic points, namely level 0 SP, level 1 SP and level 2 SP. However, such semantic points may be determined based on different points on the update timeline 318. In an embodiment, individual dialogue turn and associated information may be indicated level 0 SP. For example, “user A suggests schedule meeting”, “user B suggests burger café at 4th st.” etc., is considered as level 0 SP. The various information provided at level 0 SP may be used to define level 1 SP. For example, “user A, B, C agreed to meet at Burger restaurant at 7PM” is considered as level 1 SP. Moreover, information at level 0 SP and level 1 SP may be used to define information at level 2 SP. For example, “user A, B, C were interested in Burger restaurant” is defined as level 2 SP. Further, the above illustrated embodiment having three SP levels is in nature, and the HSP module 802 may determine any number of levels for semantic points based on the requirement.

Further, in an embodiment, for determining HSPs, two or more semantic points (SPs) from same or different levels of semantic points may be compared to establish common characteristic. The determined common characteristic may be termed as semantic relation. For example, level 1 SP “User B Changes mind to Burger restaurant” is determined from two level 0 SP “User B Suggests Burger Cafe on 4th st.” and “User B agrees for Burger Restaurant”. In both the level 0 SPs, “User B” is a common actor and the slot information for “POI” is changed from “Burger Cafe” to “Burger Restaurant”. Hence, both the Actor and POI information combined gives clue that the User B agrees to venue change, which corresponds to semantic relation between the semantic points under consideration.

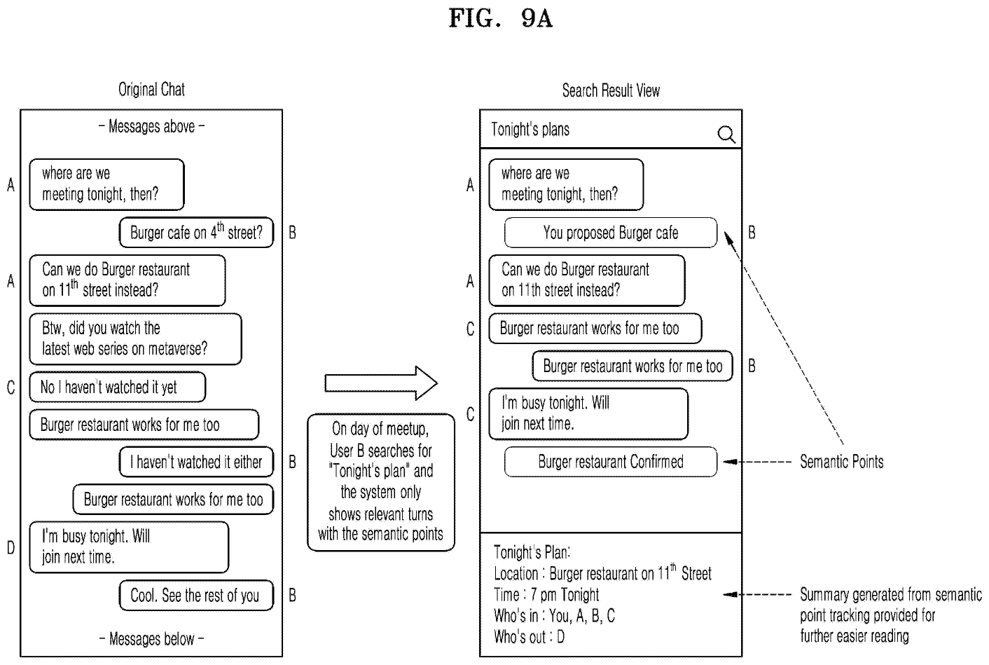

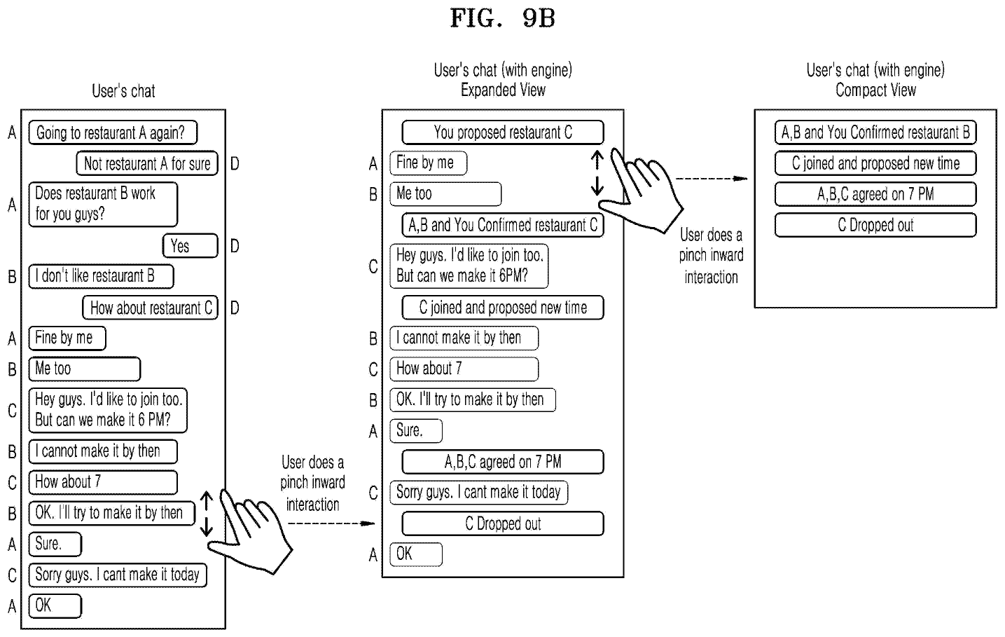

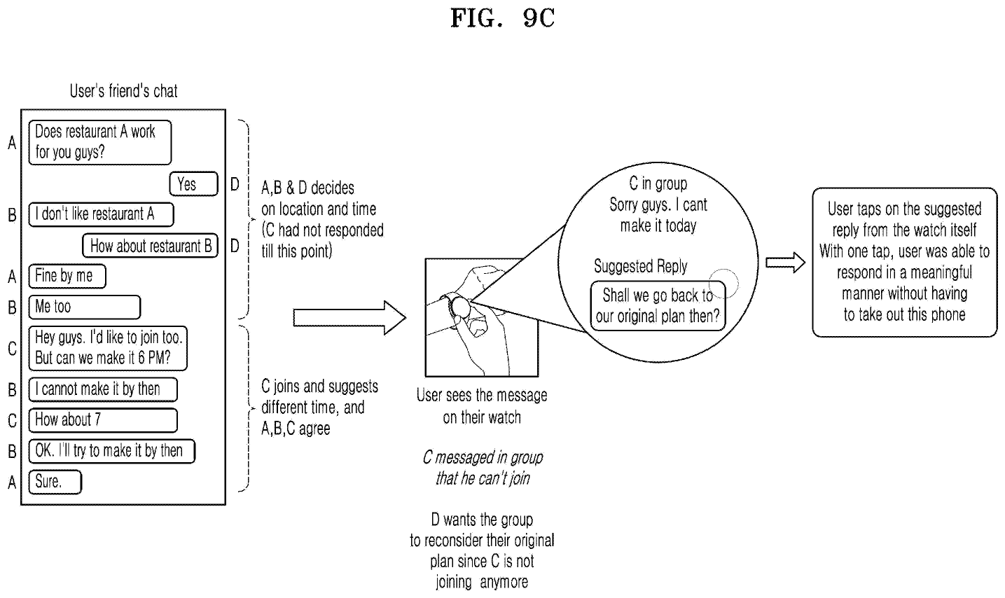

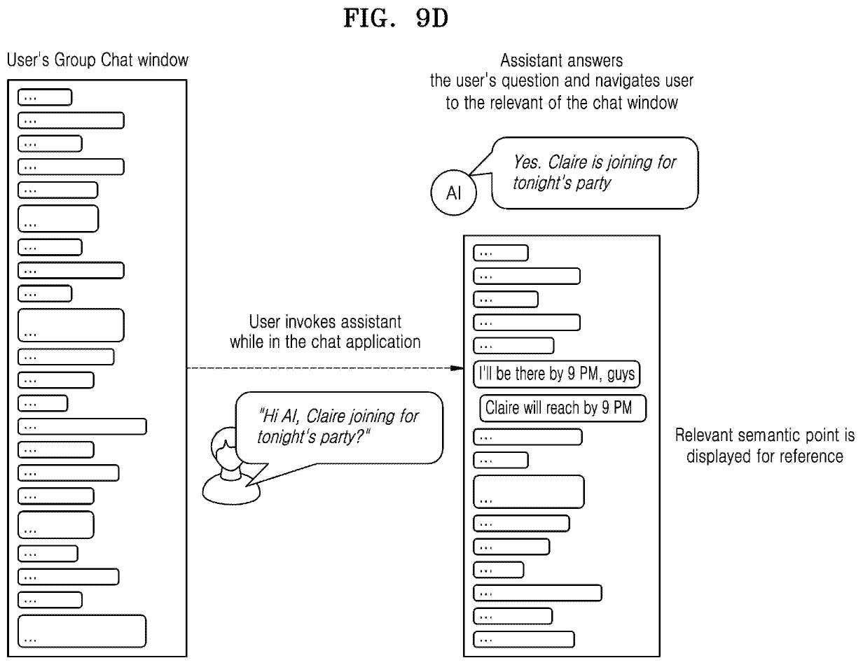

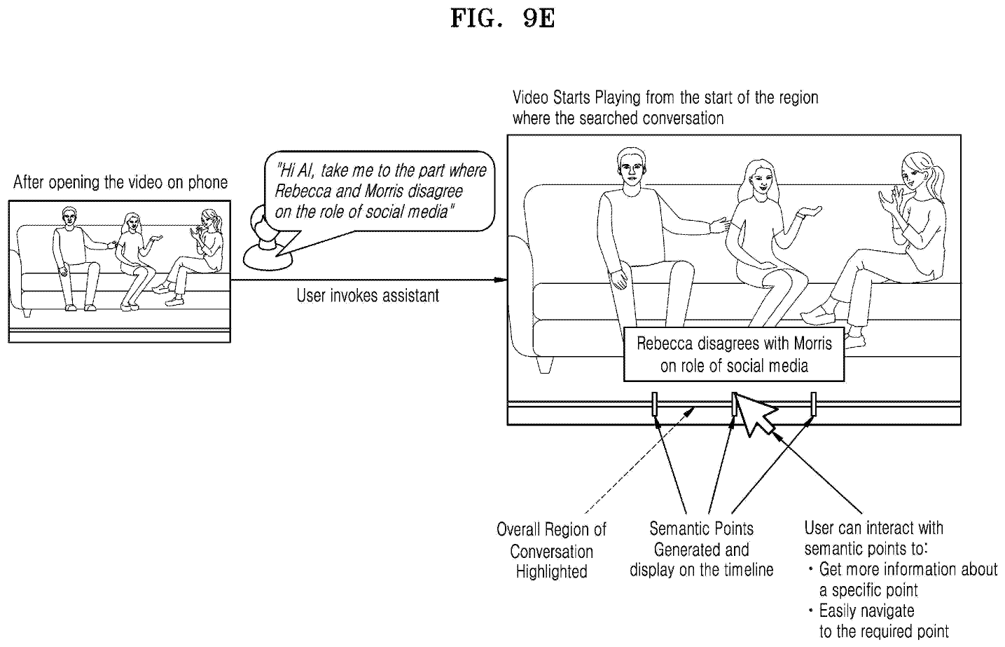

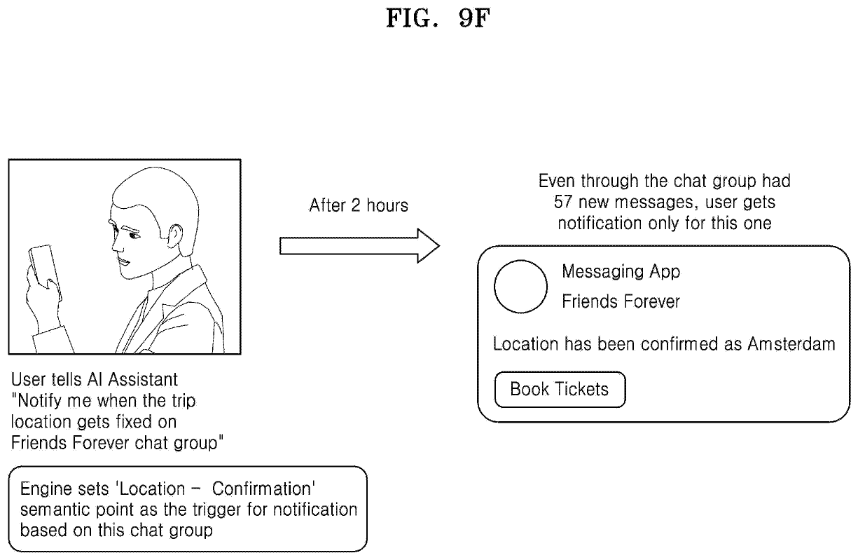

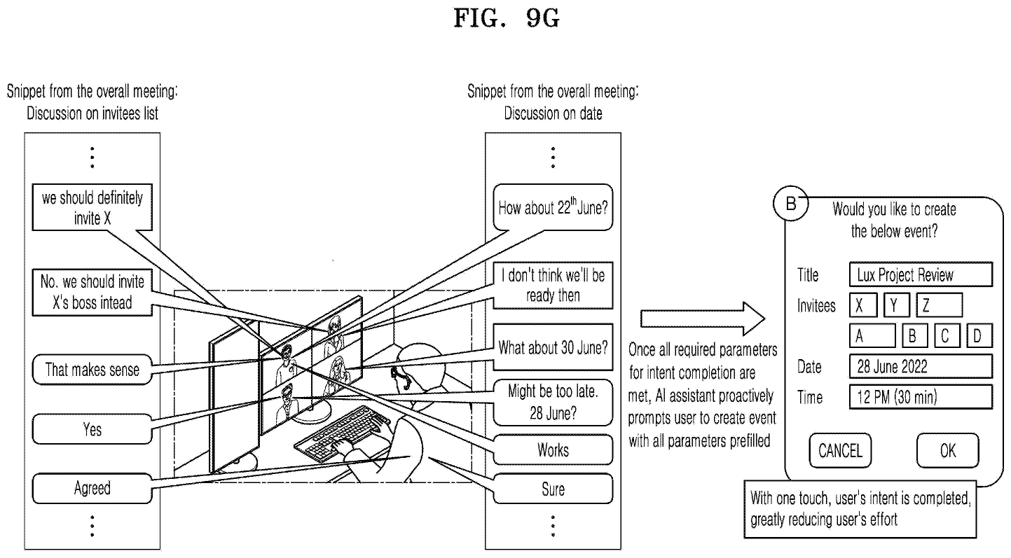

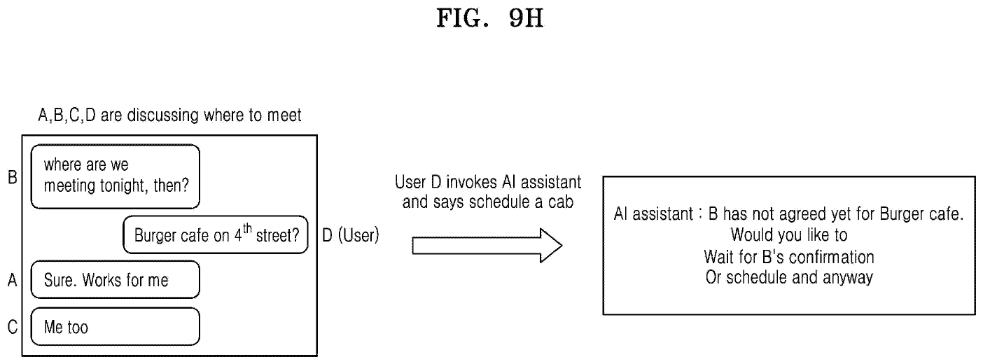

FIGS. 9A, 9B, 9C, 9D, 9E, 9F, 9G, and 9H illustrate various usage scenarios of a system for determining semantic points in a human-to-human conversation, according to various embodiments of the disclosure.

FIG. 9A, illustrates a scenario of easy topic tracking and improved glance-ability through semantic point search, according to an embodiment of the disclosure.

Referring to FIG. 9A, a user's friends chat group where a discussion for meeting happened a while ago, among users namely user A, user B, user C and user D. Now, a user B wishes to remember details of the meeting plans (ex. where it is, what time, who all is joining, etc.) is illustrated. However, the user is busy at work, and he does not have time to read all the messages and find the information from the same. In this scenario, on the day of meet, the user B may simply search for “tonight's plan” and the system 104, 201 may only show relevant dialogue turns with the determined semantic points. Specifically, in response to user search, the system 104, 201 may only display dialogue turns on a user screen which directly contribute to the final goal of the searched information. Further, the system 104, 201 may also highlight semantic points which may provide improved glance-ability of the content. Further, in response to the user search, the system 104, 201 may also provide a summary which may be generated based on semantic point tracking. The generated summary may further enhance reading of intended conclusion.

FIG. 9B illustrates a scenario of using high level semantic points to enable compact view of a conversation, according to an embodiment of the disclosure.

Referring to FIG. 9B, a scenario where a user opens a chat group after a time gap and wishes to see what developments have happened to a plan within a short span of time is illustrated. Therefore, to achieve this, the user simply pinch inwards on the chat using a touchscreen display and the system 104, 201 may reduce the chat and display semantic points along with other important information. The action may be reversed by simply receiving a pinch outward command form the user. In some embodiments, the user may further reduce the chat by performing the pinch inward action again and the system 104, 201 may only display semantic points. The system 104, 201 may utilize high level semantic point generation to display the result to the user. Thus, the system 104, 201 may provide a total control to a user over the conversation to have quick and easy reading of relevant information.

FIG. 9C illustrates a scenario of dialogue suggestion generation using high level semantic points, according to an embodiment of the disclosure.

Referring to FIG. 9C, a scenario where users A, B, C and D were discussing in the group chat about meet up at a restaurant and user D is currently at an office meeting and cannot take check his phone is illustrated. Therefore, in this scenario, the system 104, 201 may display the intended conclusion of the group chat to the user over a smart watch of the user connected to the user's phone. The system 104, 201 may also display a suggested reply based on the conclusion of the group chat. The system 104, 201 may utilize the higher level semantic points to display the desired conclusion and suggested reply. In additional embodiments, the system 104, 201 may also learn and improve the suggested replies based on user response to the reply suggested by the system 104, 201 at the first instance.

FIG. 9D illustrates a scenario of navigating and extracting specific information using semantic-point-based search, according to an embodiment of the disclosure.

Referring to FIG. 9D, a scenario where a lot of chat has happened since the last time the user had opened the chat group is illustrated. Now, user wishes to know if his best friend ‘Claire’ is joining for tonight's party. But user does not have patience to go through 40+ messages. In such scenario, the system 104, 201 may utilize the semantic point related information to identify a specific dialogue turn corresponding to the search. In the illustrated embodiment, the user search has been implemented by way of AI assistant installed within the user's electronic device.

FIG. 9E illustrates a scenario of navigating to region of interest within a video using semantic points, according to an embodiment of the disclosure.

Referring to FIG. 9C, a scenario where a user wants to refer a specific section of a multi-party interview video where a specific member has disagreement with another member on a specific topic is illustrated. But the user doesn't remember what time (in the video) it occurred. In response of such a query of the user, the system 104, 201 may utilize a transcript associated with the video and determine semantic points to provide the desired results to the user. Specifically, the system 104, 201 may utilize the semantic points associated with the HHC conversation in the video to highlight a specific section of the video, where a specific member has disagreement with another on a specific topic, as desired by the user.

FIG. 9F illustrates a scenario of reducing notification frequency using semantic point-based triggers, according to an embodiment of the disclosure.

Referring to FIG. 9F, a scenario, where a user is discussing with his ‘Friends forever’ chat group about going on a trip is illustrated. But since the group has very frequent messages (and hence notifications), user wants to mute the group. At the same time, the user may also want to know if the location for trip has been confirmed—so that he can book his tickets asap. So, he can't mute the group either. In such a scenario, the user may simply request the system to notify when the trip location gets fixed on the group. The user may provide the request using the AI assistant installed within his user device. The system 104, 201 may utilize the semantic points to check for “Location—confirmation”. Upon determining the semantic point, the system 104, 201 may trigger the desired notification. Thus, the system 104, 201 may reduce notification frequency and improves notification relevance.

FIG. 9G illustrates a scenario of enabling relevant proactive prompts from AI assistant through semantic point-based triggers, according to an embodiment of the disclosure.

Referring to FIG. 9G, a scenario where in a work meeting, users A, B, C and D are discussing about a setting up review meeting with stakeholders for a project they are working on is illustrated. During the meeting, they may have discussed multiple points including the agenda of the meeting, who all need to be invited, date and time, etc. In such a scenario, the system 104, 201 may keep a track of the intent and relevant parameters associated with users including who have confirmed, who are yet to confirm etc. Further, the system 104, 201 may be able to proactively assist the user in creating an event in relation to the meeting using the tracked intent and relevant parameters with minimal efforts. In some embodiments, the system 104, 201 may assist an AI assistant installed within a user device to create such an event.

FIG. 9H illustrates a scenario of reliable AI assistance for intent completion using semantic point understanding, according to an embodiment of the disclosure.

Referring to FIG. 9H, a scenario where a user is discussing with their friends about meeting up is illustrated. The location is agreed upon by 3 out of 4 participants. At this point the user may try to book a cab via AI assistant. In such scenario, the system 104, 201 may invoke and assist the AI assistant to display a message indicating that one of the participants has not confirmed yet, and if the user still wishes to book the cab. Thus, the system 104, 201 may make the AI assistant more reliable.

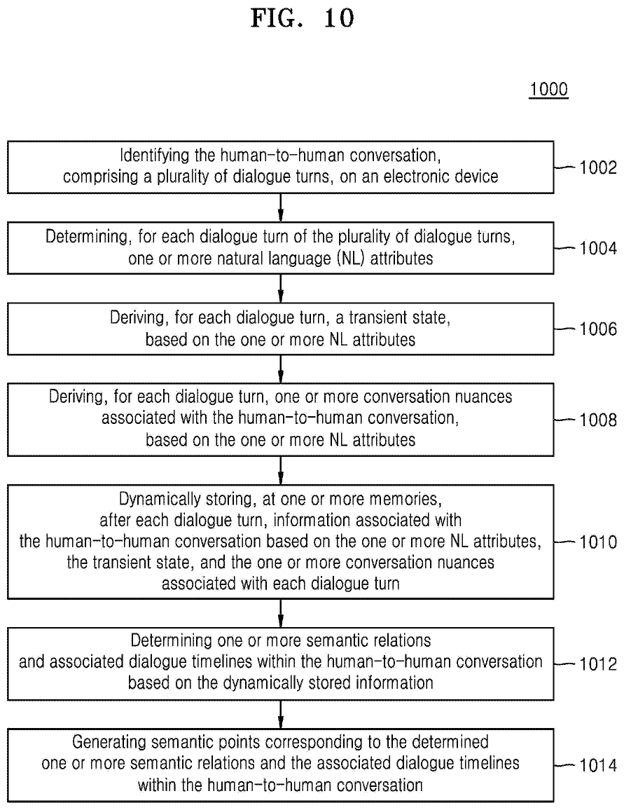

FIG. 10 illustrates a process flow of a method for determining semantic points in a human-to-human conversation, according to an embodiment of the disclosure.

Referring to FIG. 10, the steps of the method 1000 may be performed by the system 104, 201, which may be integrated within an electronic device of a user or provided separately.

At operation 1002, the method 1000 includes identifying the human-to-human conversation, comprising a plurality of dialogue turns, on an electronic device.

At operation 1004, the method 1000 includes determining, for each dialogue turn of the plurality of dialogue turns, one or more natural language (NL) attributes. The one or more NL attributes comprises at least one of an intent, dialogue act, a named entity, and a relation among the one or more NL attributes from the one or more dialogue turns from the human-to-human conversation.

At operation 1006, the method 1000 includes deriving, for each dialogue turn, a transient state, based on the one or more NL attributes. Further, deriving the transient state for each dialogue turn may include assigning one of a temporary, confirmed, and ignored labels to each of the one or more NL attributes based on the one or more dialogue turns of the human-to-human conversation.

At operation 1008, the method 1000 includes deriving, for each dialogue turn, one or more conversation nuances associated with the human to human conversation, based on the one or more NL attributes. Further, deriving the one or more conversation nuances for each dialogue turn comprises generating one of an agreement, a disagreement, a change in mind, an alternative proposal, and a denial for each dialogue turn to model the uncertainty in the human-to-human conversation.

At operation 1010, the method 1000 includes dynamically storing, at one or more memories, after each dialogue turn, information associated with the human-to-human conversation based on the one or more NL attributes, the transient state, and the one or more conversation nuances associated with each dialogue turn. In another embodiment, the method includes dynamically updating, at the one or more memories, after each dialogue turn, the stored information associated with the one or more NL attributes of the human-to-human conversation based on the transient state and the one or more conversation nuances associated with each dialogue turn. The one or more memories include a user preference memory, a cache memory, and a final goal memory.

In an embodiment, dynamically updating the stored information comprises transiting information between the cache memory and the final goal memory based on the conversation nuance. In another embodiment, dynamically updating the stored information comprises updating information at the user preference memory based on the transient state associated with each dialogue turn. Further, the method includes dynamically updating, at the one or more memories, the stored information associated with the human-to-human conversation after each dialogue turn based on one or more NL attributes, the transient state, and one or more conversation nuance labels and creating an update timeline based on dynamically updating of the stored information. The update timeline comprises update points associated with each dialogue turn. In a further embodiment, each of the update points comprise information associated with the one or more NL attributes, the transient state, conversation nuance labels, NL representation of the update point along with one or more variations.

At operation 1012, the method 1000 includes determining one or more semantic relations and associated dialogue timelines within the human-to-human conversation based on the dynamically stored information.

At operation 1014, the method 1000 includes generating semantic points corresponding to the determined one or more semantic relations and the associated dialogue timelines within the human-to-human conversation. In an embodiment, the steps of generating the semantic points may include generating, across a plurality of levels, one or more hierarchical semantic points based on the update points in the update timeline, combining the one or more hierarchical semantic points across the plurality of levels to generate more high-level semantic points and associating one or more NL variations based on the combined one or more high-level semantic points to represent the semantic points.

While the above discussed steps in FIG. 10 are shown and described in a particular sequence, the steps may occur in variations to the sequence in accordance with various embodiments.

The disclosure provides for various technical advancements based on the key features discussed above. Further, the disclosure may enable quicker and easier chat consumption experience by enabling user to easily track a specific topic in a multi-party conversation. Further, the disclosure enables a user to easily find and navigate to a specific piece of information discussed in a multi-party conversation and providing an easily readable compact view of the overall conversation with key information highlighted.

The disclosure may also enable reliable and smart Artificial Intelligence (AI) assistance to users by correctly understanding intended parameters from a multi-party conversation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for determining semantic points in a human-to-human conversation, the method comprising:
identifying the human-to-human conversation, comprising a plurality of dialogue turns, on an electronic device;
determining, for each dialogue turn of the plurality of dialogue turns, one or more natural language (NL) attributes;
deriving, for each dialogue turn, a transient state, based on the one or more NL attributes;
deriving, for each dialogue turn, one or more conversation nuances associated with the human-to-human conversation, based on the one or more NL attributes;
dynamically storing, at one or more memories, after each dialogue turn, information associated with the human-to-human conversation based on the one or more NL attributes, the transient state, and the one or more conversation nuances associated with each dialogue turn;
determining one or more semantic relations and associated dialogue timelines within the human-to-human conversation based on the dynamically stored information; and
generating one or more semantic points corresponding to the determined one or more semantic relations and the associated dialogue timelines within the human-to-human conversation.

2. The method of claim 1, wherein the one or more NL attributes comprises at least one of an intent, dialogue act, a named entity, and a relation among the one or more NL attributes from the plurality of dialogue turns from the human-to-human conversation.

3. The method of claim 1, wherein deriving the transient state for each dialogue turn comprises assigning one of a temporary, confirmed, and ignored labels to each of the one or more NL attributes based on the plurality of dialogue turns of the human-to-human conversation.

4. The method of claim 1, wherein deriving the one or more conversation nuances for each dialogue turn comprises generating one or more labels for each dialogue turn to model a level of uncertainty in the human-to-human conversation.

5. The method of claim 1, further comprising:
dynamically updating, at the one or more memories, after each dialogue turn, the stored information associated with the one or more NL attributes of the human-to-human conversation based on the transient state and the one or more conversation nuances associated with each dialogue turn,
wherein the one or more memories include a user preference memory, a cache memory, and a final goal memory.

6. The method of claim 5, wherein dynamically updating the stored information comprises transiting information between the cache memory and the final goal memory based on the one or more conversation nuances.

7. The method of claim 5, wherein dynamically updating the stored information comprises updating information at the user preference memory based on the transient state associated with each dialogue turn.

8. The method of claim 5, further comprising:
dynamically updating, at the one or more memories, the stored information associated with the human-to-human conversation after each dialogue turn based on one or more NL attributes, the transient state, and one or more conversation nuance labels; and
creating an update timeline based on dynamically updating of the stored information,
wherein the update timeline comprises update points associated with each dialogue turn.

9. The method of claim 8, further comprising:
generating the one or more semantic points based on the update points in the update timeline; and
combining the one or more semantic points to generate one or more hierarchical semantic points.

10. The method of claim 8, wherein each of the update points comprise information associated with the one or more NL attributes, the transient state, conversation nuance labels, NL representation of the update points along with one or more variations.

11. The method of claim 1, further comprising:
determining an NL representation along with a range of the associated plurality of dialogue turns for a user of the human-to-human conversation based on the generated one or more semantic points.

12. The method of claim 1, further comprising:
determining at least one dialogue turn from among the one or more dialogue turns of the human-to-human conversation that contribute directly to the one or more semantic points based on the one or more semantic points and one or more update points associated with dialogue turns; and
determining a compressed version of the one or more dialogue turns based on the one or more semantic points and the at least one dialogue turn,
wherein the compressed version of the one or more dialogue turns is displayed on a user interface for a user of the human-to-human conversation.

13. The method of claim 1, further comprising:
generating the dialogue timelines based on one or more update points, after each dialogue turn, associated with the dynamically storing of the information associated with the human-to-human conversation.

14. A system for determining semantic points in a human-to-human conversation, the system comprising:
an identifying module 300configured to identify the human-to-human conversation, comprising a plurality of dialogue turns, on an electronic device;
a natural language (NL) attribute generator module 302configured to determine, for each dialogue turn of the plurality of dialogue turns, one or more NL attributes;
a transient state estimator module 304configured to derive, for each dialogue turn, a transient state, based on the one or more NL attributes;
a conversation nuance (CN) classifier module 306configured to derive, for each dialogue turn, one or more conversation nuances associated with the human-to-human conversation, based on the one or more NL attributes;
a turn memory update module 308configured to dynamically store, at one or more memories, after each dialogue turn, information associated with the human-to-human conversation based on the one or more NL attributes, the transient state, and the one or more conversation nuances associated with each dialogue turn; and
a hierarchical semantic point (HSP) module 310configured to:
determine one or more semantic relations and associated dialogue timelines within the human-to-human conversation based on the dynamically stored information, and
generate the semantic points corresponding to the determined one or more semantic relations and the associated dialogue timelines within the human-to-human conversation.

15. The system as claimed in claim 14,
wherein the turn memory update module is configured to:
dynamically update, at the one or more memories, after each dialogue turn, the stored information associated with the one or more NL attributes of the human-to-human conversation based on the transient state and the one or more conversation nuances associated with each dialogue turn, and
wherein the one or more memories include a user preference memory, a cache memory, and a final goal memory.

16. The system as claimed in claim 15, wherein the turn memory update module is configured to:
dynamically update, at the one or more memories, the stored information associated with the human-to-human conversation after each dialogue turn based on one or more NL attributes, the transient state, and one or more conversation nuance labels; and
create an update timeline based on dynamically updating of the stored information,
wherein the update timeline comprises update points associated with each dialogue turn.

17. The system as claimed in claim 16, wherein to generate the semantic points, the HSP module is configured to:
generate one or more semantic points based on the update points in the update timeline; and
combine the one or more semantic points to generate one or more HSPs.

18. The system as claimed in claim 14, wherein the HSP module is configured to:
determine an NL representation along with a range of the associated plurality of dialogue turns for a user of the human-to-human conversation based on the generated semantic points.

19. The system as claimed in claim 14, wherein the HSP module is configured to:
determine at least one dialogue turn from among the one or more dialogue turns of the human-to-human conversation that contribute directly to the semantic points based on the semantic points and one or more update points associated with dialogue turns; and
determine a compressed version of the one or more dialogue turns based on the semantic points and the at least one dialogue turn,
wherein the compressed version is displayed on a user interface for a user of the human-to-human conversation.

20. The system as claimed in claim 14, wherein the HSP module is configured to:
generate the dialogue timelines based on one or more update points, after each dialogue turn, associated with the dynamically storing of the information associated with the human-to-human conversation.
